(19) United States
(12) Patent Application Publication
(10) Pub. No.: US 2002/0120537 A1
(43) Pub. Date: Aug. 29, 2002

(54) Web based system and method for managing business to business online transactions

(76) Inventors: Dominic Morea, Massapequa, NY (US); Julia Campbell, Westlake, OH (US); Keshav Talwar, Northport, NY (US); George S. Zirkel, North Babylon, NY (US)

Correspondence Address: John S. Beulick, Esq., Armstrong Teasdale LLP, Suite 2600, One Metropolitan Sq., St. Louis, MI, 63102, US

(21) Appl. No.: 09/795,958

(22) Filed: Feb. 28, 2001

(51) Int. Cl. G06F 17/60

(52) U.S. Cl. 705/35

(57) ABSTRACT

A Business to Business (B2B) online registration method to manage transactions over the Internet is disclosed. The B2B system implements the online registration method utilizing a web-enabled interactive database to automate the processing of online registrations of buyers and sellers, verifying credits of the buyers and sellers, generating online account numbers for transactions processing, finalizing the procedural details to manage the transactions between willing buyers and sellers over the Internet and tracking/reporting status of the transactional details as necessary to effectively manage the business.

A portion of the disclosure of this patent document contains material that is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### BACKGROUND OF THE INVENTION

This invention relates generally to Business to Business (B2B) registration, and more particularly, to network-based systems and methods to facilitate participation in an e-commerce marketplace for buyers and sellers through B2B registration.

Currently, no single credit review score card exists that can be leveraged to approve suppliers for payment processing of credit, Automated Clearing House (ACH), International Money Transfer, Escrow, Payment Scheduling, Net settlement, financing, letters of credit, lines of credit, and authentication for Digital Certificates. Furthermore, there is no on-line registration process commercially available for credit approval of payments from a buyer to a seller with instant credit decision making and certificate issuance in a B2B Internet market segment. In order to automate the on-line registration process that can serve as a single point of entry to the Business to Business (B2B) environment, credit policy needs to be developed to encompass all of the payment options and service features that are being offered. Additionally, there are no solutions available or offered to buyers and sellers to transact business in a trusted environment that is integrated within the Internet marketplace. Lack of ability to access a “cash register” over the Internet to initiate/process transactions hampers businesses' ability to grow their business with minimum financial risk associated with a poor credit rating of their customers. In addition, current approaches, which are largely paper based or manual, do not offer buyers and suppliers expeditious credit decision making on their behalf thereby delaying the transaction. Furthermore, delay in credit review process impacts ongoing risk mitigation among parties involved in the transaction.

### BRIEF SUMMARY OF THE INVENTION

The Internet (i.e. Net) marketplace enables business communities with similar business needs to create and participate in an e-commerce marketplace. The value proposition the Internet marketplace brings to it's participating members is access to a global mass market with a limited marketing investment, streamlining the due diligence process, reduced procurement costs, order fulfillment, transportation logistics, and payment processing support. Many of the buyers and suppliers who trade in the Internet marketplace are unknown parties.

A Business to Business (B2B) Virtual Registration System (i.e. BBVRS) assists Net marketplaces in creating and maintaining “Trusted Communities”. The BBVRS provides complete end-to-end payment, trust/security products, and services for companies operating in the marketplace. The online market place consists of several different market segments, one buyer to one seller, one seller to many buyers, one buyer to many suppliers, and many buyers to many suppliers.

In an exemplary embodiment, a searchable web-based system collects, tracks and disseminates real time information, regarding Buyers and Sellers. In another exemplary embodiment of the invention, a web-based method is utilized to manage transactions between buyers and sellers using a server system coupled to a centralized interactive database and at least one client system. The method includes receiving user information into a centralized database, storing the user information into various sub-sections of the centralized database to create a user profile and cross-referencing the user profile against a unique identifier for easy retrieval and update, approving the users for online transactions; and finally, retrieving the user profile from the centralized database in response to an inquiry to facilitate electronic payments online for products or services sold as part of online transactions. There are different versions of processes, computer programs, apparatus, databases and systems are disclosed.

The BBVRS in one embodiment, includes a web-enabled interactive database to automate a transaction process for managing transactions between the buyers and sellers online and allowing buyers or sellers to access cash registers to make appropriate payments. The BBVRS captures all transaction details and provides on-line, up-to-date information upon request. The BBVRS tracks details regarding a specific transaction from inception to completion and provides a status of these details to users. In the exemplary embodiment, the system utilizes a Relational Database with a client user interface front-end for administration and a web interface for standard user input and reports. Information is accessed in the database through Structured Query Language (SQL). The BBVRS includes a user profiles database as well as transaction details database for use in automating documentation, monitoring and tracking activities associated with management of transactions.

The BBVRS supports various levels of management hierarchy and provides access to individuals based on the position held by the individual within the business entity. The BBVRS has capability to download data extracted to populate commercialized database programs or spread sheet software, which provides the end-user with additional flexibility. Similarly, the data extracted can be uploaded to the BBVRS from commercialized database programs or spread sheet software.

The BBVRS provides a formalized process to track and manage the transactions between various buyers and sellers after they have completed the registration process. The BBVRS also provides a cost benefit by streamlining the management process associated with B2B transactions to improve accountability and performance.

### BRIEF DESCRIPTION OF THE DRAWINGS

FIG. 1 is a simplified block diagram of a Business to Business Virtual Registration System (BBVRS) including a server system and a plurality of client systems connected to the server system;

FIG. 2 shows a configuration of the database within a database server of the server system shown in FIG. 1;

FIG. 3 is an exemplary embodiment of the process flow detailing the registration and activation transaction;

FIG. 4 is an exemplary embodiment of a Transaction flow detailing the authorization and settlement flow for Automated Clearing House (ACH);

FIG. 5 is an alternative exemplary embodiment of the Transaction flow detailing the authorization and settlement flow;

FIG. 6 provides an overview of exemplary B2B Architecture Components;

FIG. 7 is an exemplary embodiment of a first user interface welcoming a new buyer;

FIG. 8 is an exemplary embodiment of a second user interface describing seven distinct steps that the user must take to complete the application quickly and easily, online;

FIG. 9 is an exemplary embodiment of a third user interface describing key criteria that the user must meet before the user proceeds with the online registration;

FIG. 10 is an exemplary embodiment of a General Information user interface;

FIG. 11 is an exemplary embodiment of a user interface to facilitate input of reference information required under the Reference Section identified in FIG. 10;

FIG. 12 is an exemplary embodiment of a user interface to facilitate input pertaining to funding information required under the Funding Section identified in FIG. 10;

FIG. 13 is an exemplary embodiment of an Authorization Agreement user interface;

FIG. 14 is an exemplary embodiment of a user interface to facilitate input pertaining to Payment Types information required under the Payment Types Section identified in FIG. 10;

FIG. 15 is an exemplary embodiment of a user interface to provide information to the buyer or the seller on Service Fees information required under the Service Fees Section identified in FIG. 10;

FIG. 16 is an exemplary embodiment of a user interface to provide information to the buyer or the seller on missing information or invalid entries from the application to complete the application when the buyer or the seller has selected the Application Review Section identified in FIG. 10; and

FIG. 17 is an exemplary embodiment of a user interface providing an advisory message to the buyer or the seller to contact the administrator online through e-mail or through the telephone, if there are any problems associated with the registration process.

### DETAILED DESCRIPTION OF THE INVENTION

Exemplary embodiments of systems and processes that facilitate integrated network-based electronic reporting and workflow process management related to Business to Business Virtual Registration System (BBVRS) are described below in detail.

The BBVRS facilitates electronic commerce transactions among individual buyers and suppliers, as Business to Business (B2B) Internet commerce becomes more pervasive. The BBVRS allows buyers and sellers access to many payment options without having to take the trade off-line, which is the current method available for business to business payments other than credit cards.

The BBVRS handles registration for buyers and sellers from inception to completion and helps create a linkage for business transaction processing. The value proposition created by the BBVRS brings participating buyers and sellers an access to a global mass market with a limited marketing investment, streamlining the due diligence process, reduced procurement costs, order fulfillment, transportation logistics, and payment processing support.

The BBVRS can be structured in several different ways to support Horizontal Marketplace, Vertical Marketplace, Auction Marketplace, Catalog Aggregators and Trading Exchanges. Horizontal Marketplaces fulfills the needs of the marketplace for specific types of purchases across industries while Vertical 20 Marketplace satisfies the needs of the marketplace for all purchasing needs within a specific industry. Auction Marketplaces allow multiple buyers to bid for products from individual suppliers whereas a Reverse Auction allows buyers to post their needs for a product or service and suppliers bid to fulfill the request for service. Catalog Aggregators centralize product catalogs from multiple vendors in a standardized format to facilitate product search and comparison with pre-defined prices and multiple features. Trading Exchanges are a forum for multiple buyers and suppliers with well defined products (normally commodities) that have high price volatility and require two-way negotiation.

The BBVRS includes a proprietary transactional payment platform supporting both United States and International clients. The platform supports an easily integrated payment solution imbedded into various Net markets including auctions, catalog aggregators, and trading exchanges for both vertical and horizontal Net marketplaces.

The platform provides connectivity and supports multiple direct interfaces to many Net marketplaces and external service providers. In addition to the traditional Data Payment Processing engines, the BBVRS Transaction Platform easily integrates with third party, “horizontal” service providers (such as financing partners). The BBVRS extends the payment service offerings to include other value-added services and/or new forms of Internet payments germane to the B2B marketplace. In general, some of the services envisioned could be Financing/Liquidity, Document Delivery, Logistics, etc.

The business to business virtual registration process allows buyers and suppliers to quickly establish a B2B account online. The registration process includes business rating service(s), credit review/approval for payment processing (when applicable), issuance of corporate and individual authentication services, registration to conduct business in the Net marketplace, and management reporting. The key to success for the registration process is serving as a single entry point of information that allows set-up for all payment methods offered, available features (including future horizontal services) and functionality. The registration process drives the integration efforts to the Net marketplace, buyers, and suppliers. Credit Review and Approval, issuance of Internet Commerce Account (ICA), payment activation, and the issuance of digital authentication certificates is done via the registration process. The main focus of product distribution is to offer a modular payment processing solution that easily fits across many vertical and horizontal exchanges made up of many small to medium sized buyers and suppliers.

The registration process collects all demographic data for buyers and suppliers. The system has the following capabilities:

1) Developing joint partnership to create brand awareness;

2) Displaying and recording different pricing structures for suppliers;

3) Serving multiple Net marketplaces; and

4) Accumulating & distributing Information necessary for approval of traditional and non-traditional payments.

There are two distinct types of risk associated with online transactions: credit and fraud. The fraud risk parameters could result from charge-backs, invalid sales, buyer/supplier fraud, kiting, factoring, counterfeit transactions, and lost or stolen information. Most fraud losses in the B2B space generate from charge-backs, non-performance by buyers and suppliers, and “Not Sufficient Funds” (NSF). In addition, fraud may occur by accepting orders and billing even if business does not plan to ship merchandise since they are going out of business.

A complete credit review must be provided on each supplier who is requesting to extend the credit in terms of payment processing and financing through the BBVRS. New account credit investigation for buyers and suppliers include:

1) Systematic bureau interfaces to personal and commercial credit bureaus(domestic and International) and other external service organization to assist in credit review process;

2) Ability to access US Government Edgar, UK: Company House, Better Business Bureau etc.;

3) Tools used for credit review which include industry specific score cards, etc.;

4) Systematic inquiries to positive and negative database files, and Verification of business references;

5) Perform Risk Assessment;

6) Create credit rating;

7) Create Business rating where the business entity involved in developing rating does not incur credit risk;

8) Account queuing;

9) Credit officer review and evaluation;

10) Credit decision made;

11) Automated notification to the buyer or the seller;

12) Certification Authentication requirements; and

13) Pre-Approval capabilities for additional payment alternatives and services.

The BBVRS automates the manual authentication process to determine the information provided by the buyer/supplier is accurate at the time before digital certificate issuance. The manual authentication process referenced above includes the Receipt of the “Letter of Authorization” on company letterhead, Confirmation of Proof of Right—Articles of Incorporation or Company Registration, Confirmation of Ownership of the domain name, and the Confirmation of Employment of technical contact or other authorized individuals via email.

The systems and processes facilitate, for example, electronic submission of information using a client system, automated extraction of information, and web-based registration for buyers and sellers. The system provides a Transaction platform for the B2B Process including registration of buyers and sellers based on the information that was acquired from Buyers & Sellers, manage requirements relating to Credit Review and Decisioning Process, handle Scoring Process and Financial Credit Rating standards, and manage exchange payment ratings.

The systems and processes are not limited to the specific embodiments described herein. In addition, components of each system and each process can be practiced independent and separate from other components and processes described herein. Each component and process also can be used in combination with other components and processes.

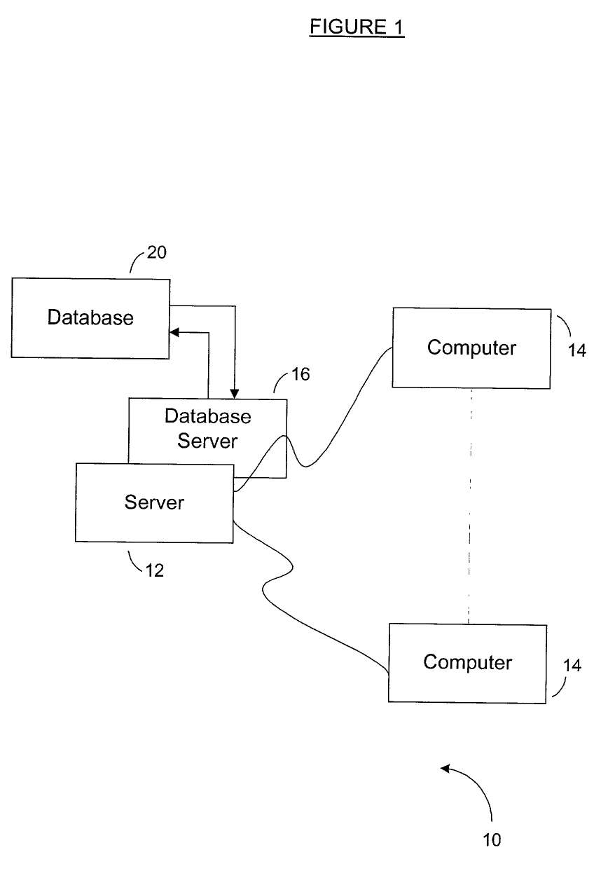

FIG. 1 is a simplified block diagram of a Business to Business Virtual Registration System (BBVRS) 10 including a server system 12 and a plurality of client systems 14 connected to server system 12. BBVRS 10 tracks information from buyers and sellers from inception to completion and provides a status to users upon request. In one embodiment, client systems 14 are computers including a web browser, such that server system 12 is accessible to client systems 14 via the Internet. Client systems 14 are interconnected to the Internet through many interfaces including a network, such as a local area network (LAN) or a wide area network (WAN), dial-in-connections, cable modems and special high-speed ISDN lines. Client systems 14 could be any device capable of interconnecting to the Internet including a web-based phone or other web-based connectable equipment. A database server 16 is connected to a centralized database 20 containing product related information on a variety of products, as described below in greater detail. In one embodiment, centralized database 20 is stored on database server 16 and can be accessed by potential users at one of client systems 14 by logging onto server system 12 through one of client systems 14. In an alternative embodiment centralized database 20 is stored remotely from server system 12.

The BBVRS utilizes a web-enabled interactive database to automate a Business to Business (B2B) virtual registration process. System 10 captures all pertinent information and provides on-line, up-to-date information to buyers and/or sellers, after authentication, upon request. In one exemplary embodiment, system 10 utilizes a Relational Database with a client user interface front-end for administration and a web interface for standard user input and reports. Information is accessed in the database through Structured Query Language (SQL). The BBVRS is a virtual registration tool to facilitate Internet Commerce. The BBVRS can also be used as a stand alone tool for internal users. System 10 supports various levels of management hierarchy and provides access to individuals based on the position held by the individual within the business entity.

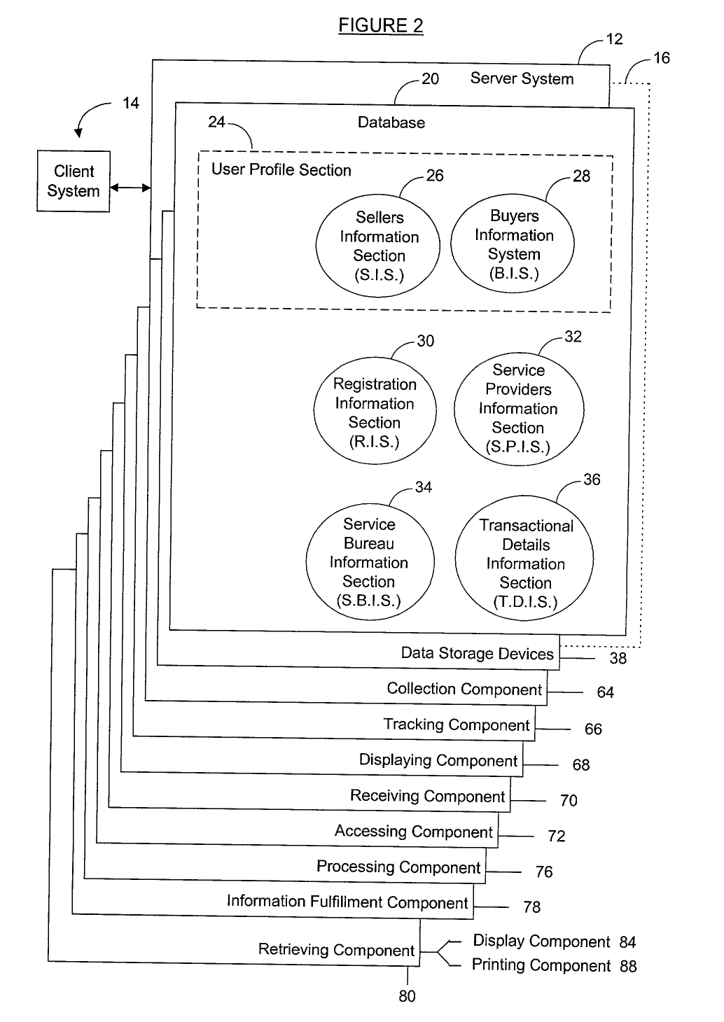

FIG. 2 shows a configuration of database 20 within database server 16 of server system 12 shown in FIG. 1. Database 20 is coupled to several separate components within server system 12, which perform specific tasks.

Database 20 is divided into a Users Profile Section 24, which is further divided into a Sellers Information Section 26, and a Buyers Information Section 28.

Sellers Information Section 26 collects and stores information on seller information including at least one of a Business name, a Business Legal Name, a Business address including a City, a State, and a Zip Code, a Name of an Authorized Signer, a Title of the Authorized Signer, a Business Phone Number, a Business Fax Number, an “Attention to” identifying where the communication must be send to, an Email address, an URL address, a Domain Name, a State of Incorporation, a Date of Incorporation, a Number of Employees, Product being Sold or Marketed, Location of the Business and It's Various Divisions, a Total Annual Sales of Business, an Estimated Annual Credit Card Sales, an Expected Average Credit Card Transaction, a Sales Tax Rate, a Refund policy, a Percentage of Credit Card Sales for Products, a Percentage of Credit Card Sales for Services, a Method of Advertising, and information whether the party registering currently using the credit card as a preferred acceptance mode of payment.

Buyers Information Section 28 collects and stores information on a Business name, a Business Legal Name, a Business address including a City, a State, and a Zip Code, a Name of an Authorized Signer, a Title of the Authorized Signer, a Business Phone Number, a Business Fax Number, an “Attention to” identifying where the communication must be send to, an Email address, an URL address, a Domain Name, a State of Incorporation, a Date of Incorporation, a Number of Employees, Product being Sold or Marketed, Location of the Business and It's Various Divisions, a Total Annual Sales of Business, an Estimated Annual Credit Card Purchases, an Expected Average Credit Card Transaction, a Sales Tax Rate, a Percentage of Credit Card Purchases for Products, a Percentage of Credit Card Purchases for Services, a Method of Advertising, and information whether the party registering currently using the credit card as a preferred method of payment, and other related information.

Database 20 is further divided into a Registration Information Section 30, a Service Providers Information Section 32, a Service Bureaus Information Section 34, and a Transactional Details Information Section 36. Sections 26, 28, 30, 32, 34, and 36 within database 20 are interconnected to update and retrieve the information as required.

Server system 12 further includes a collection component 64 for collecting information from users into centralized database 20, a tracking component 66 for tracking information, a displaying component 68 to display information, a receiving component 70 to receive a specific query from client system 14, and an accessing component 72 to access centralized database 20. Receiving component 70 is programmed for receiving a specific query from one of a plurality of users. Server system 12 further includes a processing component 76 for searching and processing received queries against data storage device 38 containing a variety of information collected by collection component 64. An information fulfillment component 78, located in server system 12, downloads the requested information to the plurality of users in the order in which the requests were received by receiving component 70. Information fulfillment component 78 downloads the information after the information is retrieved from data storage device 38 by a retrieving component 80.

Retrieving component 80 retrieves, downloads and sends information to client system 14 based on a query received from client system 14 regarding various alternatives.

Retrieving component 80 further includes a display component 84 configured to download information to be displayed on a client system's graphical user interface and a printing component 88 configured to print information.

Retrieving component 80 generates various reports requested by the user through client system 14 in a pre-determined format. System 10 is flexible to provide alternative reports and is not constrained to the options set forth above.

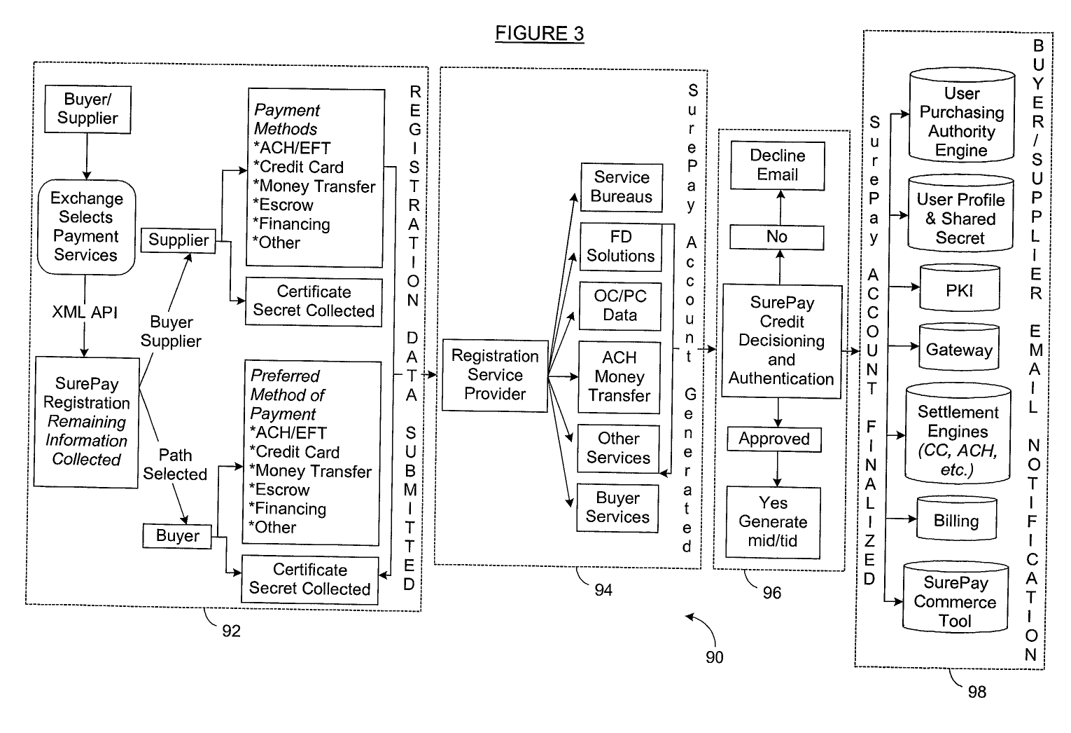

FIG. 3 is an exemplary embodiment of a process flow 90 detailing a registration and activation transaction. BBVRS 10 (shown in FIG. 1) allows a consumer/individual to accept electronic payments/transfers for products sold on-line, whether through auctions or otherwise. In general, an individual buyer/supplier applies utilizing registration process 92 for a business entity's account for payment processing. Buyer/supplier provides registration data through a pre-determined format. Registration data is submitted to registration service providers that provide various types of services for processing 94 of the registration data. Based on the registration data and the information available from registration service providers, a specific account number is generated. A credit officer located at the business entity completes a decision process 96 and either approves or disapproves the buyer/supplier. If disapproved, a notification e-mail is send to the buyer/supplier. If approved, appropriate documentation is generated and the account number is finalized. Respective databases and servers are updated 98. Upon approval, the supplier and their customers are able to access an on-line cash register where a buyer would enter a personal credit card number or other forms of personal payment information for transmission to the payment processor via a secure gateway. The funds would be transmitted electronically as specified by the buyer to the supplier via the Net marketplace.

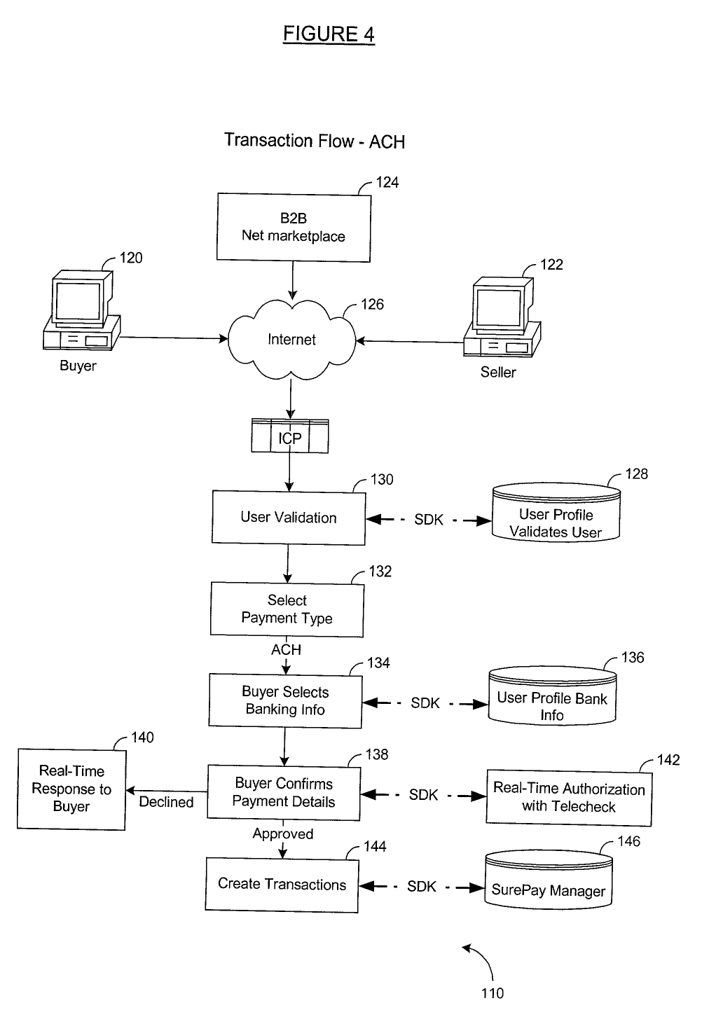

FIG. 4 is an exemplary embodiment of a Transaction flow 110 detailing the authorization and settlement flow for ACH. Whenever a registered Buyer 120 and Seller 122 agree to a commercial transaction through a B2B Net marketplace 124 utilizing world-wide Internet 126, meaning goods going from Seller 122 to Buyer 120 in exchange for money going from the Buyer to the Seller, funds transfer are triggered to settle the deal. The payment occurs through the BBVRS platform by using details of the trade combined with the user profile 128 information. Buyer 120 and Seller 122 are validated 130 through user profile 128 information

Once Buyer 120 and Seller 122 perform details of trade and confirm the order, Buyer 120 initiates the order and selects payment option ACH 132 from seller 122. Buyer 120 selects banking information 134 through a Bank Profile Banking Information 136. Buyer 120 confirms ACH transaction 138 and Seller 122 sends back an approval response 140 confirming that Seller 122 has agreed to the transaction. The debit and credit transactions produced by BBVRS 10 are sent in files to TeleCheck for real-time authorization 142. TeleCheck in turn sends transaction files to an ACH member bank for presentment. The transaction is approved and transaction details 144 are created, which are sent back to SurePay Manager 146 to generate transaction reports.

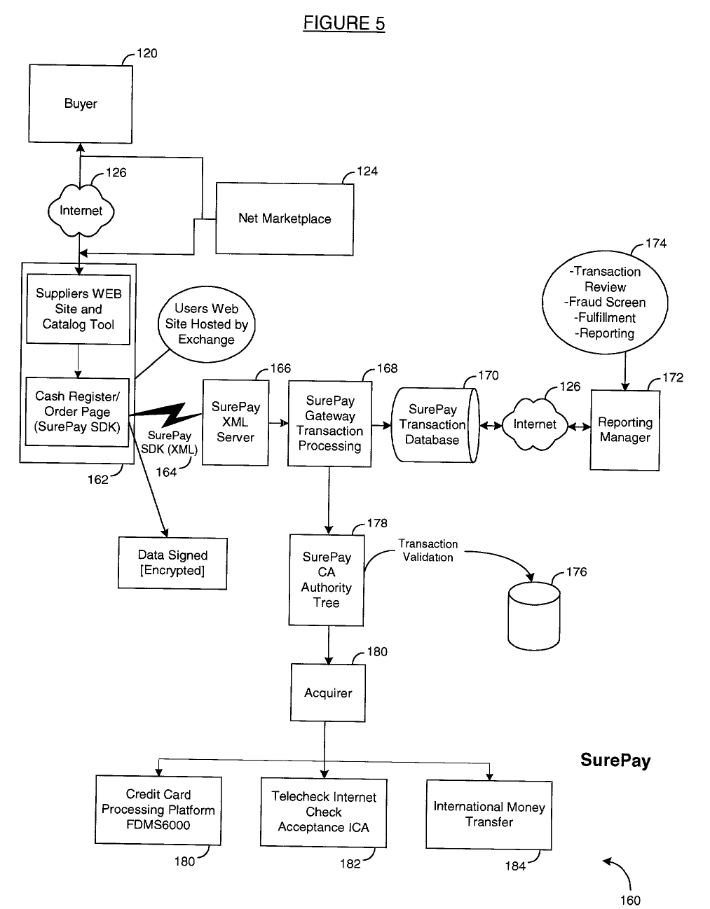

FIG. 5 is an alternative exemplary embodiment of Transaction flow 160 detailing the authorization and settlement flow. Components in the flow chart, identical to components of the flow chart shown in FIG. 4, are identified in FIG. 5 using the same reference numerals used in FIG. 4. Buyer 120 and Seller 122 conduct business over marketplace 124 through Internet 126. Buyer 120 accesses supplier's Web site and Catalog Tool 162 and initiates the transaction relating to the goods. Seller 122 displays fee information to Buyer 120 and Buyer 120 confirms buy the decision. Software Development Kit (SDK) 164 from Unibex through SurePay XML Server 166 on behalf of Seller 122 calls out to SurePay Gateway 168 with the authorization request for ACH. SurePay transaction database 170 is created which communicates through Internet 126 with Reporting Manager 172 to generate a variety of reports, validate frauds, and a transaction review 174. Real-time validation 176 is done at the time of payment request and an authorization response code 178 is returned. Authorization response code 178 includes format checks as well as hitting negative database for bad check writers, etc. Included in the call to gateway is a predetermined settlement date from Seller 122 where Buyer 120 has agreed for funds to be deducted from the account on xx/xx/xxx in the future. Email notification is sent to the buyer and the seller the day before scheduled payment of the transaction settlement occurring the next day at 10:00 p.m. EST, unless the transaction is cancelled. The funds are automatically settled on the date sent in the transaction record with email notification sent to the buyer of funds disbursement. Funds are either debited to an Acquirer's account 180 through utilizing a Credit Card Processing Platform 182, a Telecheck Internet Check Acceptance (ICA) 184, or International Money Transfer 186. Finally, the e-mail is sent to the buyer that the transaction has been approved and the goods have been shipped.

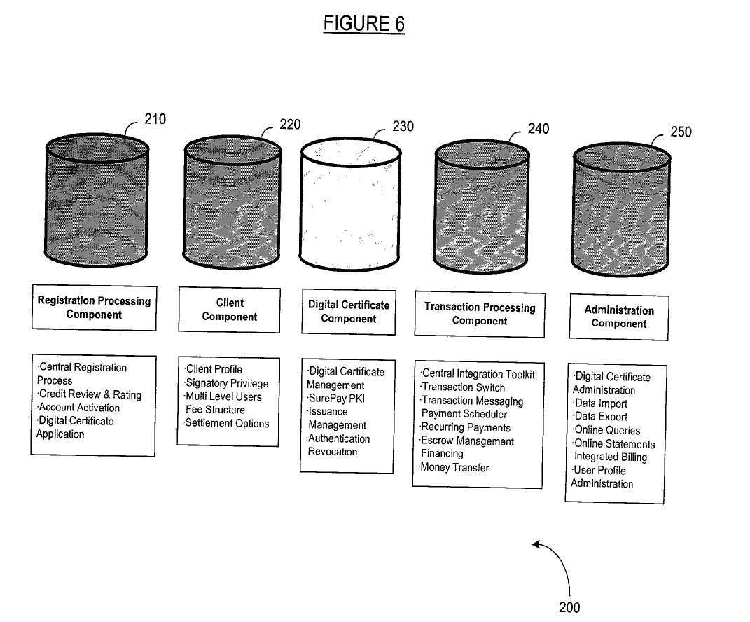

FIG. 6 provides an overview of exemplary B2B Architecture Components 200. Architecture components 200 provide various architecture components including, but not limited to, a Registration Processing Component 210, a Client Component 220, a Digital Certificate Management Component 230, a Transactional Processing Component 240, and an Administration Component 250.

Registration Processing Component 210 handles Central Registration Process, Credit Review & Rating, Account Activation, and Digital Certificate Application. Client Component 220 manages Client Profile, Signatory Privilege, Multi-level Users, Fee Structure, and various Settlement Options. Digital Certificate Management Component 230 handles Digital Certificate Management, SurePay PKI, Issuance of Digital Certificates, Management of Digital Certificates, Authentication of Digital Certificates, and Revocation of Digital Certificates. Transactional Processing Component 240 manages Central Integration Toolkit, Transaction Switch, Transaction Messaging, Payment Scheduler, Recurring Payments, Escrow Management, Financing, and Money Transfer. Administration Component 250 manages Digital Certificate Administration, Data Import, Data Export, Online Queries, Online Statements, Integrated Billing, and User Profile Administration.

Administration Component 250 further allows the administrator to import and export data from other commercial software. A user can import information from another software program into BBVRS 10 and can export the data from BBVRS 10 to allow for custom reports and analysis. The system's flexibility permits the user or an administrator to change the user profile information including the user's payment information (or company's payment information), add new users, edit user profiles, and delete inactive users. This flexibility allows the user, administrator, or anyone having an authorization to make changes or enhancements.

BBVRS architecture of system 10 as well as various components of system 10 are exemplary only. Other architectures are possible and can be utilized in connection with practicing the processes described below.

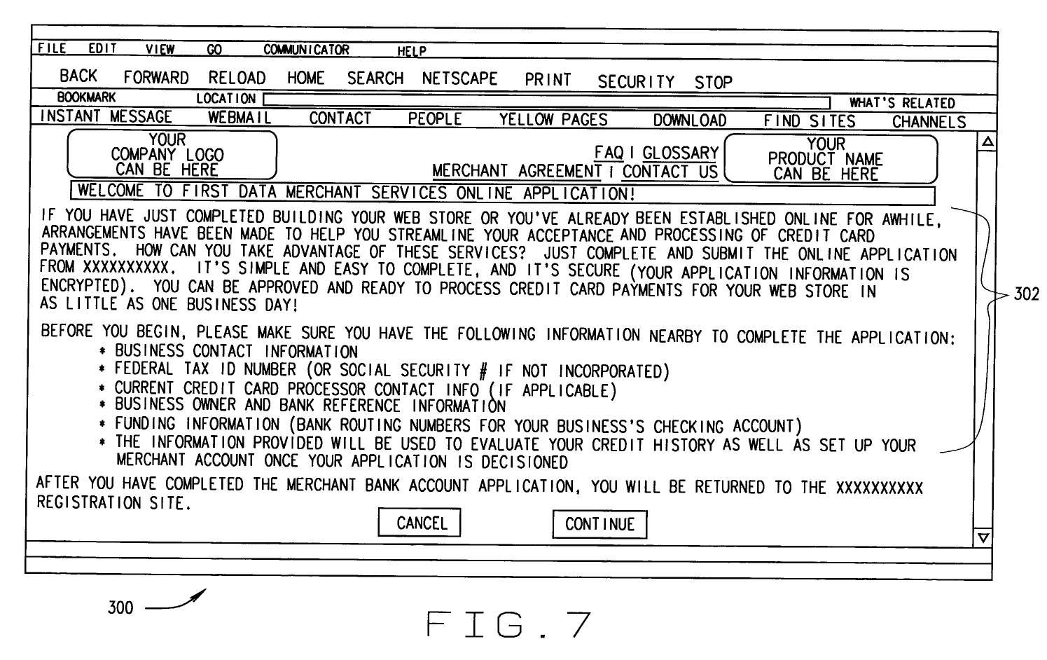

FIGS. 7 through 17 are exemplary embodiments of user interfaces utilized by the BBVRS 10 in the registration process for Buyers. Exemplary embodiments of user interfaces utilized by the BBVRS 10 in the registration process for Sellers are identical in many respects to user interfaces shown in FIGS. 7 through 17. Differences in layout of user interfaces between Sellers and Buyers are only minor and are exemplified, as and when necessary in the specification. For the purposes of explanation, a brief overview of terminology is provided hereunder:

ABA Routing Number

Also referred to as a Transit Routing Number. Directs electronic Automated Clearing House deposits to the proper bank institution.

ACH—Automated Clearing House

A method of transferring funds between the banks and financial institutions via the ACH Network.

ACH Clearing House (ACH) Network

A funds transfer governed by the Rules of NACHA that provides for the interbank clearing of electronic entries for participating financial institutions.

ACH Operator

The central clearing facility that receives entry form ODFI's, distributes the entries to RDFI's and performs settlement functions. The ACH Operator is responsible for processing electronic entries received from other ACH Operators or ODFI's.

ACH Agreement

A contract between originating company and originating financial institution to completely identify an account holders or provide information concerning a payment to the RDFI and the Receiver

ACH Authentication

The process of generating a message/data-specific code that can be used to identify the sender of the message/data and to protect the message/data from insertion, modification, deletion, or replay.

ACH Authorization

A written agreement that defines the terms and conditions between trading partners to allow payments processed through the ACH Network to be deposited in or withdrawn from his or her account at a financial institution.

Automated Bill Payment (Also Direct Payment)

A method of collection used in which a debtor gives the collecting company authorization to debit an account at his or her financial institution.

Availability

Number of days required collecting items before the trading partner have available balances.

Availability Schedule

Schedule of deposited checks showing when the funds will be available.

Average Ticket

The average dollar amount of your ACH transaction.

Banking Day

Any day on which a participating depository financial institution is open during any part of the day for carrying on substantially all its banking functions.

Batch-ACH

A group of records or documents considered as a single unit for the purpose of data processing usually a day's worth of transactions.

Buyer

Business owner who is a registered member of a trading exchange.

Buyer Account Number

A number that numerically identifies each buyer to the processor for accounting and billing purposes.

Clearing

Processing of collecting electronic items from the drawee banks after being deposited by a trading partner.

Clearing House

A voluntary association of depository institutions that facilitates the clearing of electronic items through the direct exchange of funds between members.

Compliance

Compliance to the National Automated Clearing House Association regulatory bylaws.

Corporate-to-Corporate Payments

Any of the class of automated payment formats developed for the ACH Network that allow concurrent exchange of funds and remittance information between trading partners.

Credit Entry

An entry to the record of an account to represent the transfer or placement of funds into the account.

Credit Rating

Classification of a customer's ability to repay debts and various obligations.

Credit Risk

The risk that a party to a transaction cannot provide the necessary funds, as contracted, in order for settlement to take place. Typically, credit-risk related losses arise from the failure or bankruptcy of a company.

Data Encryption

The scrambling of information sent over the Internet, only the intended users can read and understand encrypted information.

DDA

Demand Deposit Account. The individual account that is credited and or debited for deposits, fees, and adjustments.

Debit Entry

An entry to the record of an account to represent the transfer or removal of funds from the account.

Direct Payment (See Also Automated Bill Payment)

A method of collection used in the ACH Network for certain claims, generally those that are repeated over a period of time, for which the debtor gives the Originator an authorization to debit his or her account.

Effective Entry Date

The date the originating company expects payments to take place. Settlement date will be on the effective entry date or the next available business day.

Electronic Funds Transfer (EFT)

Electronic Funds Transfer is a generic terms used to describe any ACH or wire transfer.

Entry

An electronic item representing the transfer of funds in the ACH.

Error Resolution

Procedures required for resolving a trading exchange allegation that entries were improperly charged to the trading partner's account.

Exception Entry

Any entry that requires special attention for processing, examples include return entries, stop payments, notification of change, dishonored return claims, etc.

Fraud Risk—ACH

The risk that a payment transaction will be initiated or altered in an attempt to misdirect or misappropriate funds.

Funds Availability

The time at which the funds resulting from a transfer are made available to the trading partner.

Individual Identification Number

The number used by the originating company to identify the Receiver.

Item

An electronic record representing the movement of funds.

Memo Posting

An interim procedure in which credits and debits are recorded in individual accounts in a manner that allows financial institutions to reflect deposit information prior to actual posting.

NACHA

The national association that establishes the standards, rules, and procedures that enable depository financial institutions to exchange payments on a national basis.

Notification of Change (NOC)

Information sent by a RDFI to notify the ODFI that previously valid information for a Receiver has become outdated or that information contain in a pre-notification is erroneous.

Orginating Depository Financial Instituion (ODFI)

A participating financial institution that originates ACH entries at the request of and by (ODFI) agreement with its customers.

Originator

Any individual corporation or other entity that initiates entries into the Automated Clearing House System.

Posting

The process of recording debits and credits to individual account balances.

Pre-Notification (Prenote)

A non-dollar entry that may be sent through the ACH network to alert the receiving financial institution that a live dollar transaction will be forthcoming that requires the verification of the Receiver's account number.

Processor

Any organization performing data processing services in regard to ACH transaction including service bureaus, ACH Operators, etc.

Receiver

A trading exchange partner or entity, which has authorized an originator to initiate a credit or debit entry to a transaction account held at an RDFI.

Receiving Depository Financial Institution (RDFI)

Any financial institution qualified to receive ACH entries that agrees to abide by the NACHA Operating Rules and guidelines.

Recurring Transaction

A transaction that is periodically charged to the buyer's account for ongoing goods or services for which written permission has been granted by a buyer to a vendor (seller).

Referral

The message received from an ACH Processor when an attempt for authorization requires a call to the Voice Authorization Center.

Regulation E

A regulation promulgated by the Federal Reserve Board of Governors in order to ensure a minimum level of protection in disputes arising from electronic funds transfers.

Rejects

Any ACH batch file that has not been accepted by an ACH Operator because it cannot be processed, usually because of a technical error.

Represented Entry

Allows the ACH Network to be utilized to transmit re-presented entries to accounts for the collection of funds returned for insufficient funds or uncollected funds.

Returns

An ACH entry that has been returned to the ODFI by the RDFI or by the ACH Operator because it cannot be processed.

Reversals

Any ACH entries or files sent within required deadlines to “correct” or reverse previously originated entries or files.

Routing Number

A nine-digit number that identifies a specific financial institution also referred to as the ABA number.

Seller

Business owner (seller) of products.

SIC Code

The Standard Industry Classification assigned by an Acquirer for processing.

Trace Number

A 15 character code uniquely identifying each entry with a batch in an ACH file.

Trading Exchange

Forum where multiple buyers and suppliers can meet for purposes in engaging in trade and purchase of goods or services.

Trading Partner

Registered buyers or supplies that engage in trade in the e-commerce marketplace.

Transaction Code

A two digit code in the ACH record that determines whether an entry is a debit or a credit to a DDA account.

Transaction Fees

Service costs charged to a buyer on a per transaction bases.

Warehouse

“Storage” of pending files until release or settlement dates.

Zero Dollar Payment

An entry that carries a zero amount but does include payment related remittance data.

Through a series of user interfaces, the user is guided to complete the registration process and create a structure of the database within the system that tracks and manages users' transactions. The information provided through the user interfaces depicted in FIGS. 7 through 17 is stored in centralized database 20 and retrieved by server system 12 as required. Many variations of particular user interfaces or screens viewable by the user can be utilized. The following description refers to one set of screens that can be used to prompt the user, whether buyer or seller, to make the necessary inputs to enable the system to generate various reports, charts, or status reports. Of course, many variations of such screens are possible.

Referring now specifically to the drawings, FIG. 7 is an exemplary embodiment of a first user interface 300 welcoming a new buyer. User interface 300 provides general instructions 302 to the buyer relating to the registration process and advises a list of documents the buyer should compile before proceeding with the online registration.

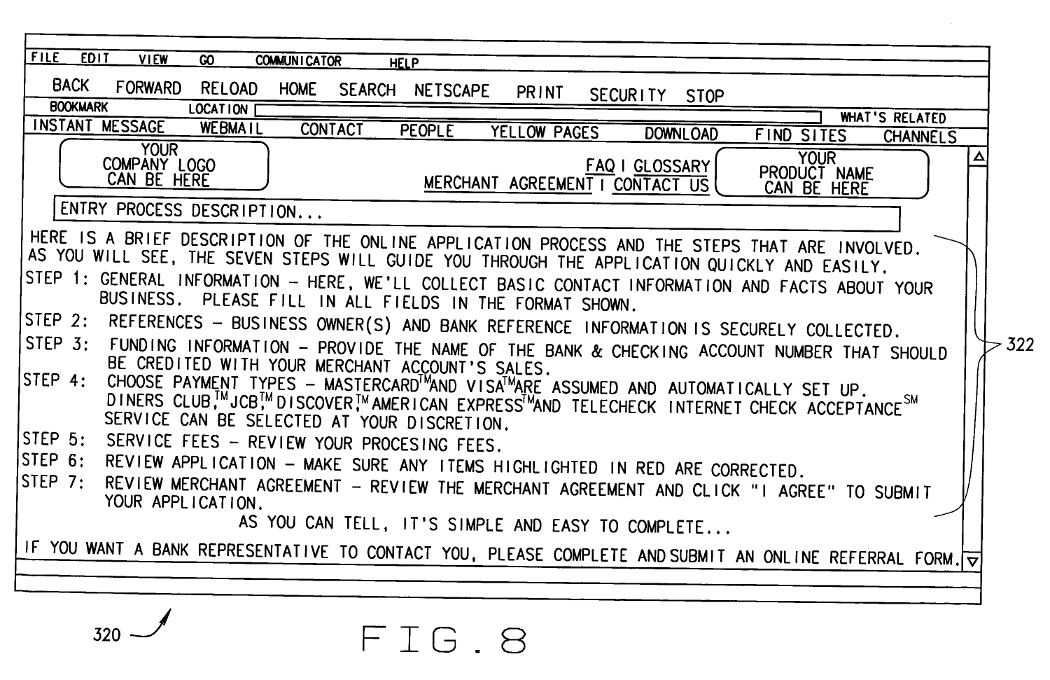

FIG. 8 is an exemplary embodiment of a second user interface 320 describing seven distinct steps 322 that the user must take to complete the application quickly and easily online.

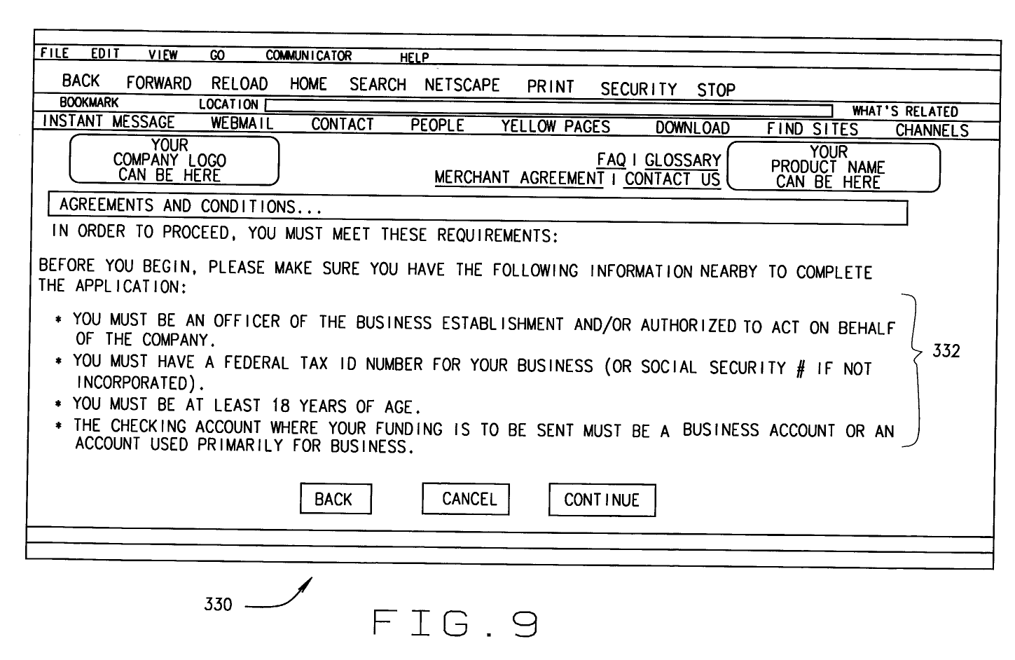

FIG. 9 is an exemplary embodiment of a third user interface 330 describing key criteria 332 that the user must meet before the user proceeds with the online registration. For example, the user must be an officer of the business establishment and must be authorized to act on behalf of the company and enter into this contractual commitment, the user must have a Federal Tax ID number for the business or Social Security number if not incorporated, the user must be at least 18 years of age, and the bank account where the funds are being withdrawn must be a business account or an account used primarily for business.

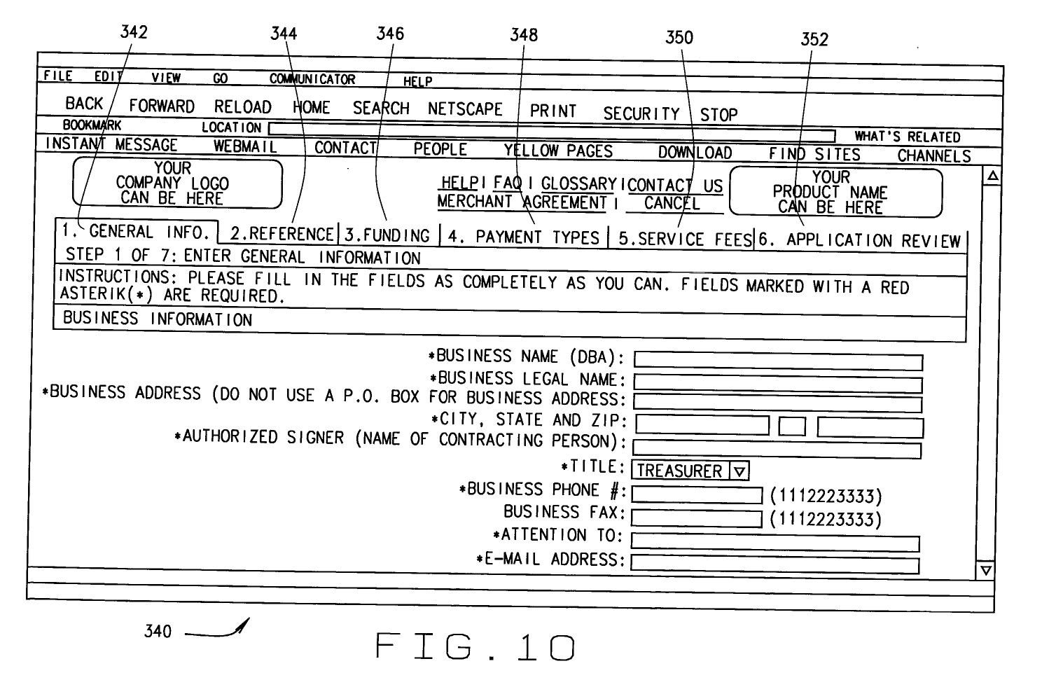

FIGS. 10 through 16 are exemplary embodiments of user interfaces to facilitate online registration for the buyer.

By selecting a specific button out of various buttons located on user interface 340 shown in FIG. 10, the user can move from one section of the application to the another. There are a total of six different sections of the online application. These sections are identified as a General Information Section 342, a Reference Section 344, a Funding Section 346, a Payment Type Section 348, a Service Fees Section 350 and an Application Review Section 352. The Buyer provides various Business Information under General Information Section 342 which includes information such as a Business name (DBA), a Business Legal Name, a Business address including a City, a State, and a Zip Code, a Name of an Authorized Signer, a Title of the Authorized Signer, a Business Phone Number, a Business Fax Number, an “Attention to” identifying where the communication must be sent to, an Email address, an URL address, a Domain Name, a State of Incorporation, a Date of Incorporation, a Number of Employees, a Product being Sold or Marketed, Location of the Business and It's Various Divisions, a Total Annual Sales of Business, Estimated Annual Credit Card Purchases, an Expected Average Credit Card Transaction, a Sales Tax Rate, a Percentage of Credit Card Purchases for Products, a Percentage of Credit Card Purchases for Services, a Method of Advertising, and information whether the party registering currently using the credit card as a preferred method of payment, and other related information.

If the registration process relates to registering a Seller, user interface 340 is modified to incorporate additional questions that the Seller needs to answer. These questions relate to a Total Annual Sales of Business, an Estimated Annual Credit Card Sales, an Expected Average Credit Card Transaction, a Sales Tax Rate, a Refund policy, a Percentage of Credit Card Sales for Products, a Percentage of Credit Card Sales for Services, a Method of Advertising, and information whether the party registering currently using the credit card as a preferred acceptance mode of payment.

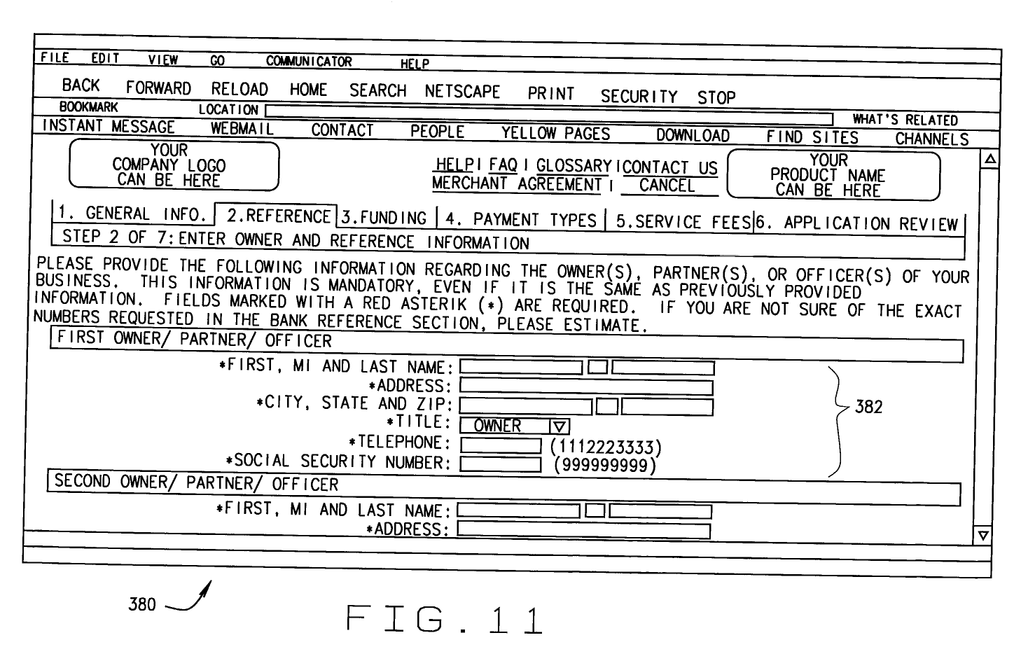

FIG. 11 is an exemplary embodiment of a user interface 380 to facilitate input of reference information required under Reference Section 344 identified in FIG. 10. Reference information required includes information on at least three references including Owners, Partners or Officers of the business. Information 382 required includes, a First Name, a Last Name, a Middle Initial, an Address including a Street Name, a City, and a Zip Code, a Title of the Person such as an Owner, a Partner, or an Officer, a Telephone Number, and a Social security Number.

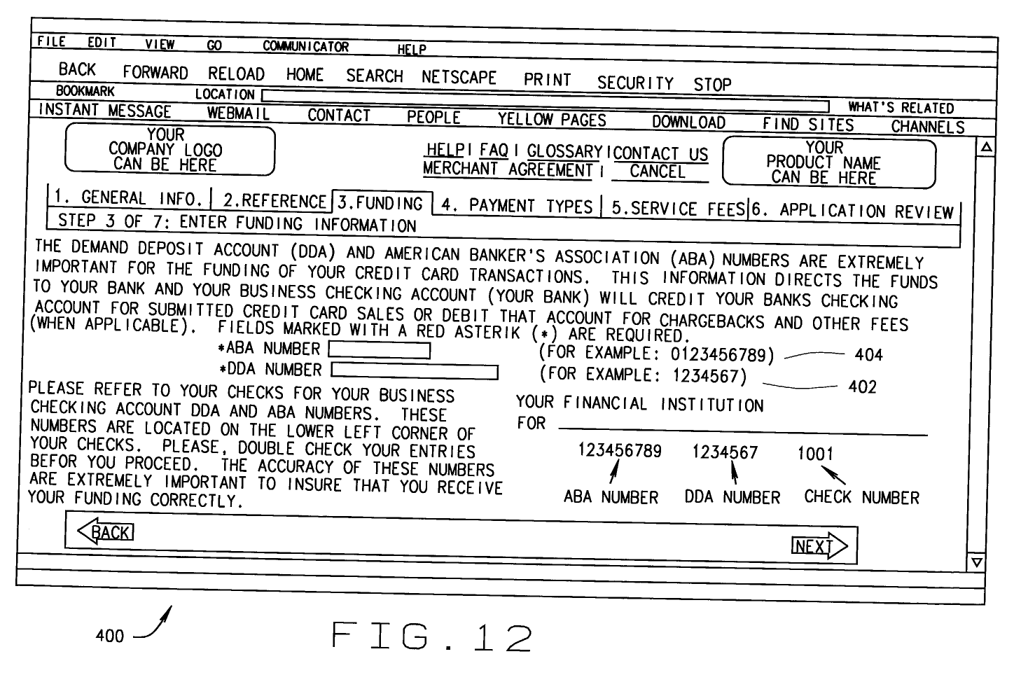

FIG. 12 is an exemplary embodiment of a user interface 400 to facilitate input pertaining to funding information required under Funding Section 346 identified in FIG. 10. A Demand Deposit Account (DDA) 402 and American Banker's Association (ABA) 404 numbers are extremely important for the correct withdrawal to process the payments. This information directs the funds to be withdrawn from the business's bank and business's specific account. BBVRS 10 debits buyer's account for payments and other fees approved by the buyer per the terms and conditions agreed between the buyer and buyer's vendor. The accuracy of these numbers is extremely important to ensure that the buyer's funds are transferred correctly

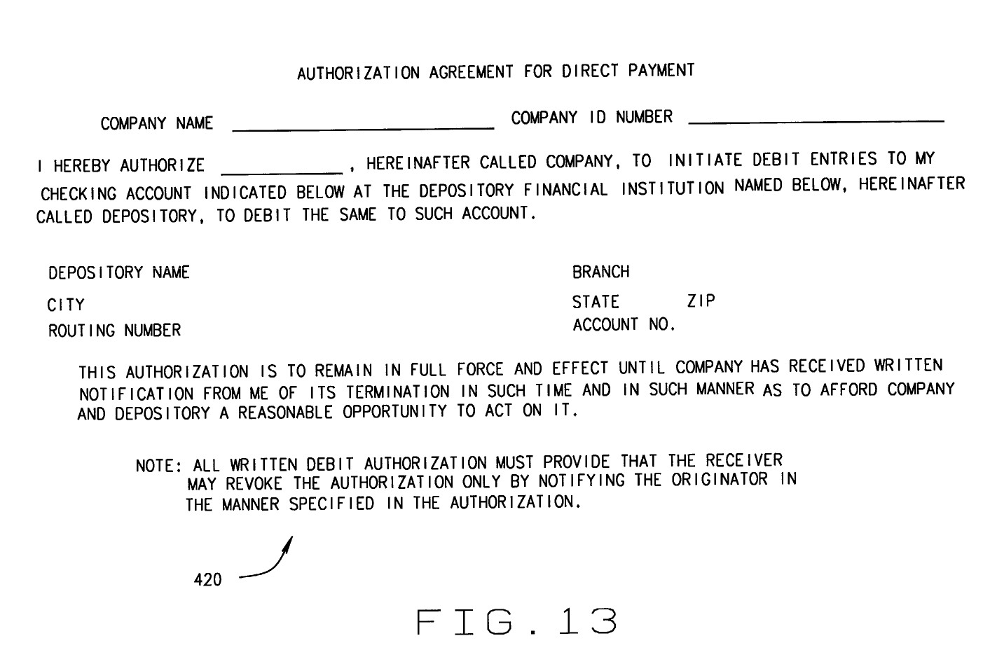

An Authorization Agreement 420, as shown in FIG. 13 is completed by the buyer to allow the business entity managing BBVRS 10 to initiate debit entries to the buyer's account.

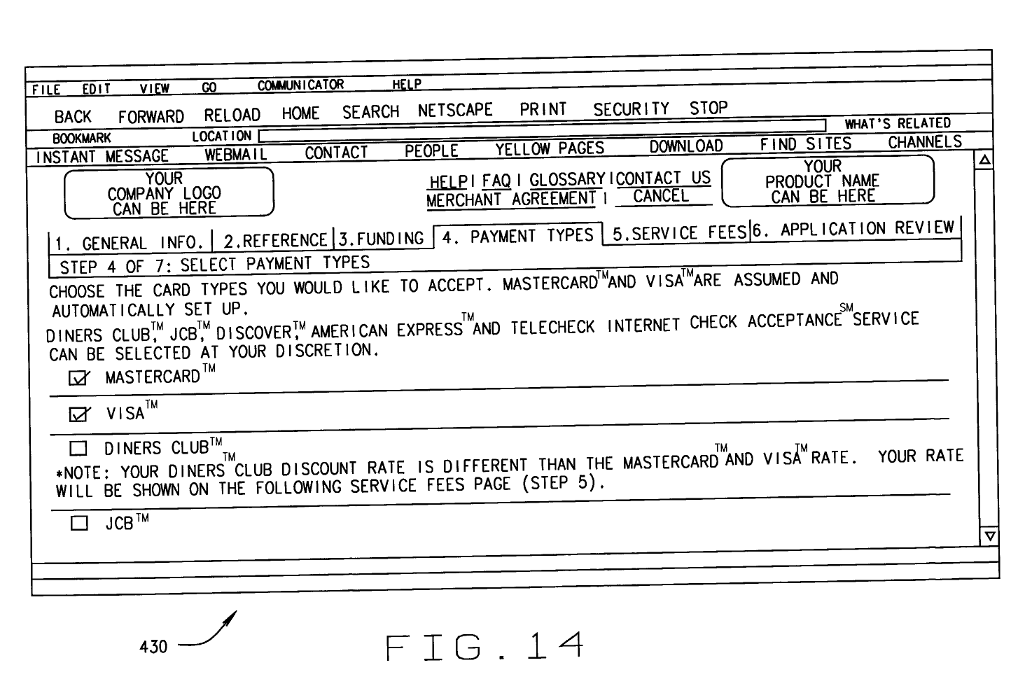

FIG. 14 is an exemplary embodiment of a user interface 430 to facilitate input pertaining to Payment Types information required under Payment Types Section 348 identified in FIG. 10. User interface 430 offers an opportunity to the Buyer to select one or more preferred methods for payment out of Diner's Club, JCB, Discover, American express, or a Telecheck Internet Check Acceptance Service. Visa and Mastercard are already set up as available options. Once the buyer identifies preferred methods for payment types, the buyer moves to the next section to review service fees.

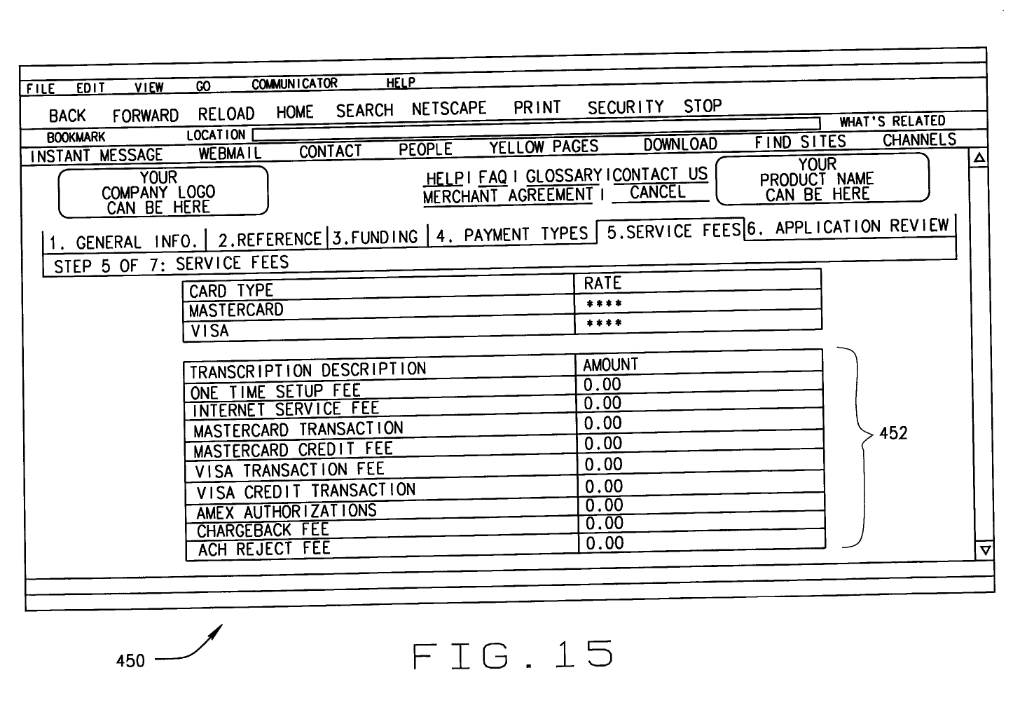

FIG. 15 is an exemplary embodiment of a user interface 450 to provide information to the buyer or the seller on Service Fees 452 information required under Service Fees Section 350 identified in FIG. 10. Service fees 452 are hard coded and become part of the contract after the buyer or the seller has agreed to the terms and conditions.

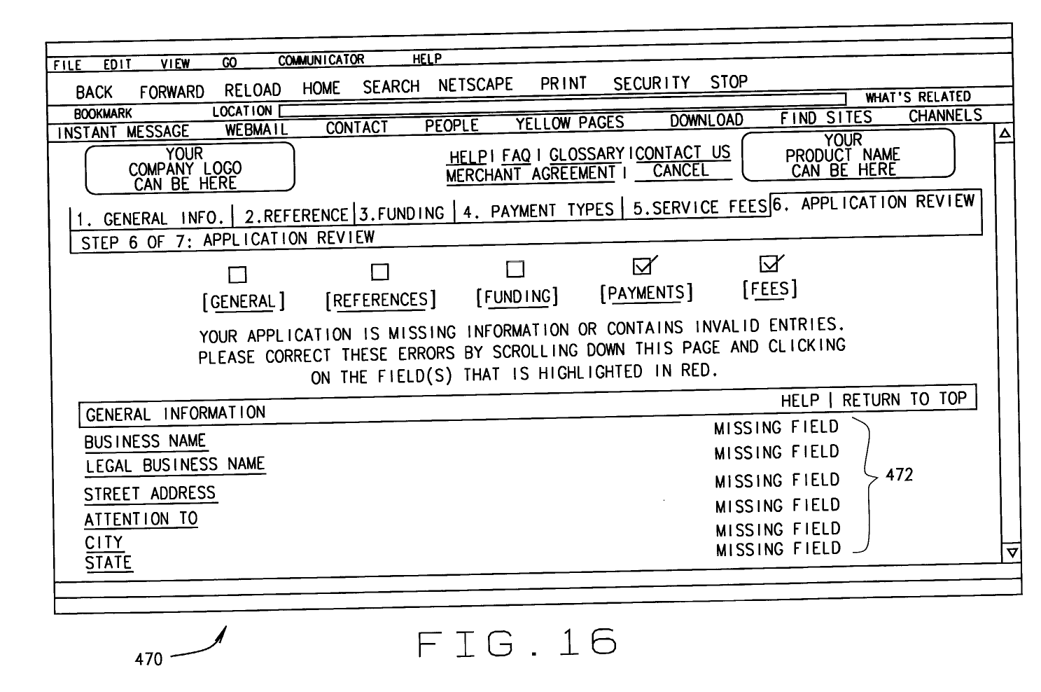

FIG. 16 is an exemplary embodiment of a user interface 470 to provide information to the buyer or the seller on missing information or invalid entries 472 from the application to complete the application when the buyer or the seller has selected Application Review Section 352 identified in FIG. 10. The buyer or the seller corrects these errors by scrolling down user interface 470 and selecting the field that is highlighted in red.

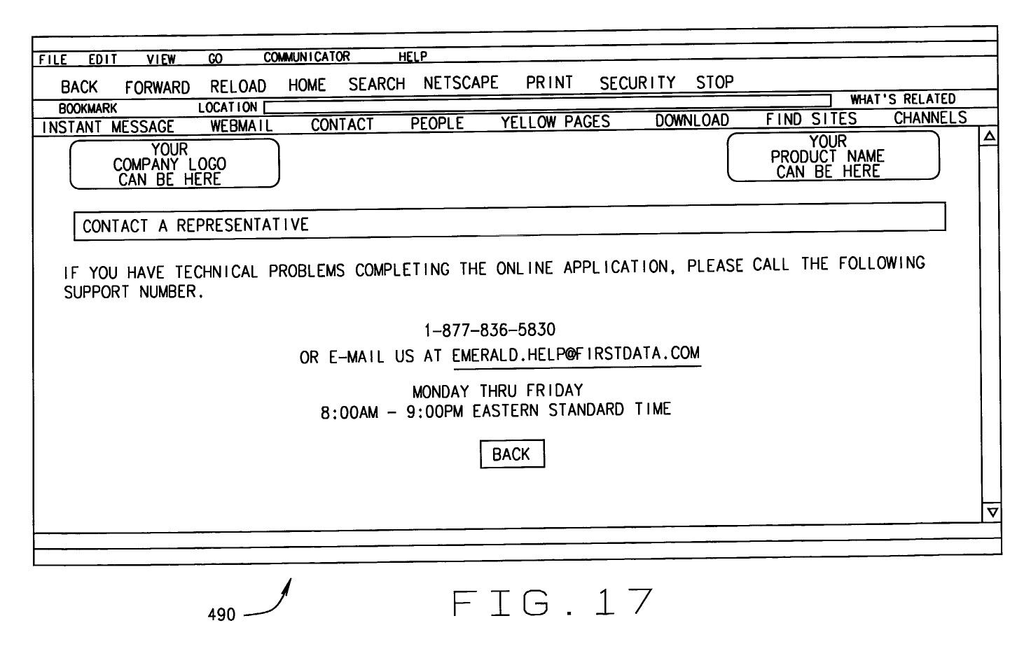

FIG. 17 is an exemplary embodiment of a user interface 490 providing an advisory message to the buyer or the seller to contact the administrator online through e-mail or through the telephone, if there are any problems associated with the registration process.

While the invention has been described in terms of various specific embodiments, those skilled in the art will recognize that the invention can be practiced with modification within the spirit and scope of the claims.

What is claimed is:

1. A method for online registration of buyers and sellers to participate in an e-commerce marketplace, using a web-based system including a server system coupled to a centralized interactive database and at least one client system, said method comprising the steps of:
receiving user information into a centralized database;
storing the user information in the centralized database to create a user profile and cross-referencing the user profile against a unique identifier for easy retrieval and update;
approving the users for online transactions; and
retrieving the user profile from the centralized database in response to an inquiry to facilitate electronic payments online for products or services sold as part of online transactions.

2. A method according to claim 1 wherein said step of receiving user information further comprises the step of receiving information on buyers and sellers into various sub-sections of the database.

3. A method according to claim 2 wherein said step of receiving information on buyers and sellers further comprises the step of receiving buyer information including at least one of a Business name, a Business Legal Name, a Business address including a City, a State, and a Zip Code, a Name of an Authorized Signer, a Title of the Authorized Signer, a Business Phone Number, a Business Fax Number, an “Attention to” identifying where the communication must be send to, an Email address, an URL address, a Domain Name, a State of Incorporation, a Date of Incorporation, a Number of Employees, Product being Sold or Marketed, Location of the Business and It's Various Divisions, a Total Annual Sales of Business, an Estimated Annual Credit Card Purchases, an Expected Average Credit Card Transaction, a Sales Tax Rate, a Percentage of Credit Card Purchases for Products, a Percentage of Credit Card Purchases for Services, a Method of Advertising, and information whether the party registering currently using the credit card as a preferred method of payment, and other related information.

4. A method according to claim 2 wherein said step of receiving information on buyers and sellers further comprises the step of receiving seller information including at least one of a Business name, a Business Legal Name, a Business address including a City, a State, and a Zip Code, a Name of an Authorized Signer, a Title of the Authorized Signer, a Business Phone Number, a Business Fax Number, an “Attention to” identifying where the communication must be send to, an Email address, an URL address, a Domain Name, a State of Incorporation, a Date of Incorporation, a Number of Employees, Product being Sold or Marketed, Location of the Business and It's Various Divisions, a Total Annual Sales of Business, an Estimated Annual Credit Card Sales, an Expected Average Credit Card Transaction, a Sales Tax Rate, a Refund policy, a Percentage of Credit Card Sales for Products, a Percentage of Credit Card Sales for Services, a Method of Advertising, and information whether the party registering currently using the credit card as a preferred acceptance mode of payment.

5. A method according to claim 1 wherein said step of storing the user information further comprises the steps of:
storing buyer information including at least one of a Business name, a Business Legal Name, a Business address including a City, a State, and a Zip Code, a Name of an Authorized Signer, a Title of the Authorized Signer, a Business Phone Number, a Business Fax Number, an “Attention to” identifying where the communication must be send to, an Email address, an URL address, a Domain Name, a State of Incorporation, a Date of Incorporation, a Number of Employees, Product being Sold or Marketed, Location of the Business and It's Various Divisions, a Total Annual Sales of Business, an Estimated Annual Credit Card Purchases, an Expected Average Credit Card Transaction, a Sales Tax Rate, a Percentage of Credit Card Purchases for Products, a Percentage of Credit Card Purchases for Services, a Method of Advertising, and information whether the party registering currently using the credit card as a preferred method of payment, and other related information; and
storing seller information including at least one of a Business name, a Business Legal Name, a Business address including a City, a State, and a Zip Code, a Name of an Authorized Signer, a Title of the Authorized Signer, a Business Phone Number, a Business Fax Number, an “Attention to” identifying where the communication must be send to, an Email address, an URL address, a Domain Name, a State of Incorporation, a Date of Incorporation, a Number of Employees, Product being Sold or Marketed, Location of the Business and It's Various Divisions, a Total Annual Sales of Business, an Estimated Annual Credit Card Sales, an Expected Average Credit Card Transaction, a Sales Tax Rate, a Refund policy, a Percentage of Credit Card Sales for Products, a Percentage of Credit Card Sales for Services, a Method of Advertising, and information whether the party registering currently using the credit card as a preferred acceptance mode of payment.

6. A method according to claim 5 wherein said step of storing the user information further comprises the step of updating information comprising adding, deleting, and editing the transactions and transactions related information.

7. A method according to claim 6 wherein said step of updating the user information into the centralized database further comprises the step of entering the user information online.

8. A method according to claim 6 wherein said step of updating the user information further comprises the step of entering information at least through one of a voice activation command and a device connected to the client system.

9. A method according to claim 1 wherein said step of storing the user information further comprises the steps of:
tracking the user information on a real time basis; and
storing the user information on a real time basis by updating stored information by adding the new information to the centralized database on a real time basis to provide up-to-date deal information instantaneously to the user upon a request.

10. A method according to claim 1 wherein said step of approving the users for online transactions further comprises the step of investigating credit rating of the users by utilizing at least one of a domestic and International bureau interfaces that provide personal and commercial credit information, external service organization to assist in credit review process, US Government Edgar reports, Better Business Bureau reports, industry specific score cards, systematic inquiries to positive and negative database files, verification of business references, Performing detailed Risk Assessment Analysis, Create credit rating, Create Business rating, and Account queuing.

11. A method according to claim 10 wherein said step of step of investigating credit rating of the users further comprises the step of conducting in-depth credit officer review and evaluation.

12. A method according to claim 1 wherein said step of investigating credit rating of the users further comprises the steps of:
making credit decisions; and
notification of credit decisions.

13. A method according to claim 12 wherein said step of investigating credit rating of the users further comprises the steps of:
evaluating certification authentication requirements; and
issuing digital certificate after authenticity.

14. A method according to claim 13 wherein said step of evaluating certification authentication requirements further comprises the steps of:
receiving a Letter of Authorization on company letterhead;
confirming Articles of Incorporation to verify the company's registration status;
confirming ownership of domain names in the United States and Foreign Countries;
confirming employment of technical contact via email; and
confirming employment of a designated Super Administration User.

15. A method according to claim 1 wherein said step of approving the users for online transactions further comprises the step of providing credit approval of all payments from a buyer to a seller with instant credit decision and a certificate issuance.

16. A method according to claim 1 wherein said step of approving the users for online transactions further comprises the step of generating an account number for at least one of a buyer and a seller.

17. A method according to claim 1 wherein said method further allows buyers and sellers access to various payment options without having to take the transaction off-line.

18. A method according to claim 1 wherein said method further allows buyers and sellers access to operate in a trusted environment integrated into business to business marketplace to access a cash register over the Internet to initiate the transaction.

19. A method according to claim 1 wherein said method further allows buyers and sellers access to operate in a trusted environment integrated into business to business marketplace to access a cash register over the Internet to complete the transaction.

20. A method according to claim 1 wherein said step of retrieving the user profile information further comprises the step of printing requested information in a pre-determined format.

21. A method according to claim 1 wherein said step of retrieving the user profile information further comprises the step of providing the user profile information to at least one of a buyer and a seller depending on where the request originated from.

22. A method according to claim 1 wherein said step of retrieving the user profile information further comprises the step of receiving an inquiry from the client system, said step of receiving an inquiry further includes the step of submitting a request through at least one of pull down menus, check boxes, and hypertext links.

23. The method according to claim 23 further includes the step of displaying an HTML document downloaded by the server system.

24. A method according to claim 1 wherein said step of retrieving the user profile information in response to an inquiry further comprises the steps of:
downloading requested information from a server system; and
displaying the requested information on a client system in response to the inquiry.

25. A method according to claim 24 wherein said step of downloading further comprises the steps of:
accessing the centralized database;
searching the database regarding the specific inquiry;
retrieving information from the database; and
transmitting the retrieved information to the client system for display by the client system.

26. An online process for buyers and sellers to participate in an e-commerce marketplace after completing the regisatration, using a web-based system including a server system coupled to a centralized interactive database and at least one client system, said method comprising the steps of:
receiving user information into a centralized database; and
approving the users for online transactions.

27. The process according to claim 26 wherein said step of approving the users for online transactions further comprises the steps of:
allowing customers an on-line cash register access;
allowing a buyer to enter at least one of a personal credit card and other forms of personal payment information for transmission to the payment processor via a secured gateway for an online transaction; and
transmitting funds electronically as specified by the buyer to the supplier via the Internet to complete the online transaction and retaining an application fee on all credit decision requests.

28. The online process according to claim 27 further comprises the steps of issuing an Internet Commerce Account, activating payment processing, and triggering an issuance of digital authentication certificates via the online.

29. The online process according to claim 28 further capable of collecting demographic information about buyers and sellers.

30. The online process according to claim 29 further comprising the step of providing online help to the user by downloading a user manual on to a client device.

31. The online process according to claim 26 wherein the client system and the server system are connected via a network and wherein the network is one of a wide area network, a local area network, an intranet and the Internet.

32. A computer to facilitate an online transaction between a buyer and a seller, said computer programmed to:
receive user information into a centralized database;
store the user information into various sub-sections of the centralized database to create a user profile and cross-reference the user profile against a unique identifier for easy retrieval and update;
approve the users for online transactions;
generate an Internet Commerce Account upon successful completion of credit evaluation of the user; and
provide notification via e-mail to the user.

33. A computer according to claim 32 wherein said users comprise at least one buyer and one seller, willing to enter into a commercial transaction over the Internet, said computer displaying and recording different pricing structures for sellers.

34. A computer according to claim 32 further programmed to serve multiple Net marketplaces.

35. A computer according to claim 32 further programmed to collect information necessary for approval of traditional as well as non-traditional payments.

36. A computer according to claim 32 further programmed to handle payment via utilizing at least one of a credit card, ACH, International Money Transfer, Payment Scheduling, Net Settlement, Financing, Letters of Credit, Lines of Credit, and Authentication of Digital Certificates.

37. A computer according to claim 32 further programmed to provide flexibility to an administrator to make changes to the user information by at least one of adding, modifying and deleting the information.

38. A computer according to claim 32 wherein online transactions comprises at least one of a transaction between a willing buyer and a willing seller, an auction type transaction, a transaction originating from online catalogs, and trading exchanges transaction.

39. A computer according to claim 32 wherein online transactions comprises a reverse auction transaction between a willing seller and a willing buyer.

40. Apparatus for tracking and managing online transactions between willing buyers and willing sellers, said apparatus comprising:
a centralized database, a registration processing component, a digital certificate management component, a transaction processing component, and an administration component, said apparatus further comprising:
means for setting up at least one of a buyer and a seller profile through registration process;
means for maintaining database by adding, deleting and updating information;
means for tracking online transactions according to assigned priorities;
means for generating management reports; and
means for providing flexibility to an administrator to modify user profile information.

41. Apparatus according to claim 40 wherein said means for maintaining database further comprising at means for at least one of changing company profile option, changing payment information option, changing organization structure option, updating users option, changing administrator option, and updating product table option.

42. Apparatus according to claim 40 further comprising:
means for storing buyer information including at least one of a Business name, a Business Legal Name, a Business address including a City, a State, and a Zip Code, a Name of an Authorized Signer, a Title of the Authorized Signer, a Business Phone Number, a Business Fax Number, an “Attention to” identifying where the communication must be send to, an Email address, an URL address, a Domain Name, a State of Incorporation, a Date of Incorporation, a Number of Employees, Product being Sold or Marketed, Location of the Business and It's Various Divisions, a Total Annual Sales of Business, an Estimated Annual Credit Card Purchases, an Expected Average Credit Card Transaction, a Sales Tax Rate, a Percentage of Credit Card Purchases for Products, a Percentage of Credit Card Purchases for Services, a Method of Advertising, and information whether the party registering currently using the credit card as a preferred method of payment, and other related information; and
means for storing seller information including at least one of a Business name, a Business Legal Name, a Business address including a City, a State, and a Zip Code, a Name of an Authorized Signer, a Title of the Authorized Signer, a Business Phone Number, a Business Fax Number, an “Attention to” identifying where the communication must be send to, an Email address, an URL address, a Domain Name, a State of Incorporation, a Date of Incorporation, a Number of Employees, Product being Sold or Marketed, Location of the Business and Its Various Divisions, a Total Annual Sales of Business, an Estimated Annual Credit Card Sales, an Expected Average Credit Card Transaction, a Sales Tax Rate, a Refund policy, a Percentage of Credit Card Sales for Products, a Percentage of Credit Card Sales for Services, a Method of Advertising, and information whether the party registering currently using the credit card as a preferred acceptance mode of payment.

43. Apparatus according to claim 40 wherein said means for tracking online transactions further means for ensuring that goods are delivered to the buyer and payments are received for said goods from the seller and credited to the seller's account after pre-determined fee for the online transaction has been deducted.

44. Apparatus according to claim 40 wherein said registration processing component further comprising means for managing at least one of Central Registration Process, Credit Review & Rating Process, Account Activation Process, and a Digital Certificate Application Process.

45. Apparatus according to claim 40 wherein said client component further comprising means for managing at least one of a Client Profile, Signatory Privileges, multi level Users, Fee Structure, and various Settlement Options.

46. Apparatus according to claim 40 wherein said digital certificate management component further comprising means for handling Digital Certificate Management, SurePay PKI, Issuance of Digital Certificates, Management of Digital Certificates, Authentication of Digital Certificates, and Revocation of Digital Certificates.

47. Apparatus according to claim 40 wherein said transaction processing component further comprising means for managing a Central Integration Toolkit, a Transaction Switch, Transaction messaging, a Payment scheduler, Recurring Payments, Escrow Management, Financing, and Money Transfer.

48. Apparatus according to claim 40 wherein said administration component further comprising means for managing Digital Certificate Administration, Data Import, Data Export, Online Queries, Online Statements, Integrated Billings, and User Profile Administration.

49. Apparatus according to claim 40 wherein said administration component further comprising means for allowing an administrator to import and export data from other commercial software.

50. Apparatus according to claim 49 wherein said administration component further comprising means for permitting the administrator to change the user profile information including the users payment information, company's payment information, adding new users, editing user profiles, and deleting inactive users.

51. A web-based system for managing and tracking online transactions among buyers and a sellers, said system comprising:
a client system comprising a browser;
a storage device for storing information; and
a server system configured to be coupled to said client system and said database, said server system further configured to:
receive user information into a centralized database;
store the user information into various sub-sections of the centralized database and cross-reference the user information against an unique identifier for easy retrieval and update;
approve the users for online transactions; and
retrieve the user profile from the centralized database in response to an inquiry to facilitate electronic payments online for products or services sold as part of online transactions.

52. A system according to claim 51 wherein said server system further configured to receive information on buyers as well as sellers into various subsections of the database.

53. A system according to claim 52 wherein said server system further configured to receive buyer information including at least one of a Business name, a Business Legal Name, a Business address including a City, a State, and a Zip Code, a Name of an Authorized Signer, a Title of the Authorized Signer, a Business Phone Number, a Business Fax Number, an “Attention to” identifying where the communication must be send to, an Email address, an URL address, a Domain Name, a State of Incorporation, a Date of Incorporation, a Number of Employees, Product being Sold or Marketed, Location of the Business and It's Various Divisions, a Total Annual Sales of Business, an Estimated Annual Credit Card Purchases, an Expected Average Credit Card Transaction, a Sales Tax Rate, a Percentage of Credit Card Purchases for Products, a Percentage of Credit Card Purchases for Services, a Method of Advertising, and information whether the party registering currently using the credit card as a preferred method of payment, and other related information.

54. A system according to claim 52 wherein said server system further configured to receive seller information including at least one of a Business name, a Business Legal Name, a Business address including a City, a State, and a Zip Code, a Name of an Authorized Signer, a Title of the Authorized Signer, a Business Phone Number, a Business Fax Number, an “Attention to” identifying where the communication must be send to, an Email address, an URL address, a Domain Name, a State of Incorporation, a Date of Incorporation, a Number of Employees, Product being Sold or Marketed, Location of the Business and It's Various Divisions, a Total Annual Sales of Business, an Estimated Annual Credit Card Sales, an Expected Average Credit Card Transaction, a Sales Tax Rate, a Refund policy, a Percentage of Credit Card Sales for Products, a Percentage of Credit Card Sales for Services, a Method of Advertising, and information whether the party registering currently using the credit card as a preferred acceptance mode of payment.

55. A system according to claim 51 wherein said server system further configured to:
store buyer information including at least one of a Business name, a Business Legal Name, a Business address including a City, a State, and a Zip Code, a Name of an Authorized Signer, a Title of the Authorized Signer, a Business Phone Number, a Business Fax Number, an “Attention to” identifying where the communication must be send to, an Email address, an URL address, a Domain Name, a State of Incorporation, a Date of Incorporation, a Number of Employees, Product being Sold or Marketed, Location of the Business and It's Various Divisions, a Total Annual Sales of Business, an Estimated Annual Credit Card Purchases, an Expected Average Credit Card Transaction, a Sales Tax Rate, a Percentage of Credit Card Purchases for Products, a Percentage of Credit Card Purchases for Services, a Method of Advertising, and information whether the party registering currently using the credit card as a preferred method of payment, and other related information; and
store seller information including at least one of a Business name, a Business Legal Name, a Business address including a City, a State, and a Zip Code, a Name of an Authorized Signer, a Title of the Authorized Signer, a Business Phone Number, a Business Fax Number, an “Attention to” identifying where the communication must be send to, an Email address, an URL address, a Domain Name, a State of Incorporation, a Date of Incorporation, a Number of Employees, Product being Sold or Marketed, Location of the Business and It's Various Divisions, a Total Annual Sales of Business, an Estimated Annual Credit Card Sales, an Expected Average Credit Card Transaction, a Sales Tax Rate, a Refund policy, a Percentage of Credit Card Sales for Products, a Percentage of Credit Card Sales for Services, a Method of Advertising, and information whether the party registering currently using the credit card as a preferred acceptance mode of payment.

56. A system according to claim 51 wherein said client system is further configured with:
a displaying component for displaying various user interfaces;
a displaying component for displaying at least one of a home page user interface, a General Information user interface, a Funding user interface, a Payment Type user interface, a Service Fees user interface, an Application Review user interface, a Help user interface, a FAQ user interface, a Glossary user interface, a Contact Us user interface, a Merchant Agreement user interface; and
a sending component for sending an inquiry to the server system so that the server system can process and download the requested information to the client system.

57. A system according to claim 56 wherein the sending component functions in response to a click of a mouse button.

58. A system according to claim 56 wherein the sending component functions in response to a voice command.

59. A system according to claim 51 wherein said system further configured to be protected from access by unauthorized individuals.

60. A system according to claim 51 wherein said server system is further configured with:
a collection component for collecting information from users into the centralized database;
a tracking component for tracking information on an on-going basis;
a displaying component for displaying at least one of a home page user interface, a General Information user interface, a Funding user interface, a Payment Type user interface, a Service Fees user interface, an Application Review user interface, a Help user interface, a FAQ user interface, a Glossary user interface, a Contact Us user interface, a Merchant Agreement user interface;
a receiving component for receiving an inquiry from the client system regarding at least one of a home page user interface, a General Information user interface, a Funding user interface, a Payment Type user interface, a Service Fees user interface, an Application Review user interface, a Help user interface, a FAQ user interface, a Glossary user interface, a Contact Us user interface, a Merchant Agreement user interface; and
an accessing component for accessing the centralized database and causing the retrieved information to be displayed on the client system.

61. A system according to claim 60 wherein said server system further configured with a receiving component for receiving an inquiry to provide information from one of a plurality of users.

62. A system according to claim 60 wherein said server system further configured with a processing component for searching and processing received inquiries against the data storage device containing a variety of information collected by the collection component.

63. A system according to claim 60 wherein said server system further configured with a retrieving component to retrieve information from the data storage device.

64. A system according to claim 60 wherein said server system further configured with an information fulfillment component that downloads the requested information after retrieving from the data storage device to the plurality of users in the order in which the requests were received by the receiving component.

65. A system according to claim 60 wherein said server system further configured to:
receive buyer information including at least one of a Business name, a Business Legal Name, a Business address including a City, a State, and a Zip Code, a Name of an Authorized Signer, a Title of the Authorized Signer, a Business Phone Number, a Business Fax Number, an “Attention to” identifying where the communication must be send to, an Email address, an URL address, a Domain Name, a State of Incorporation, a Date of Incorporation, a Number of Employees, Product being Sold or Marketed, Location of the Business and It's Various Divisions, a Total Annual Sales of Business, an Estimated Annual Credit Card Purchases, an Expected Average Credit Card Transaction, a Sales Tax Rate, a Percentage of Credit Card Purchases for Products, a Percentage of Credit Card Purchases for Services, a Method of Advertising, and information whether the party registering currently using the credit card as a preferred method of payment, and other related information;
update buyer information including at least one of a Business name, a Business Legal Name, a Business address including a City, a State, and a Zip Code, a Name of an Authorized Signer, a Title of the Authorized Signer, a Business Phone Number, a Business Fax Number, an “Attention to” identifying where the communication must be send to, an Email address, an URL address, a Domain Name, a State of Incorporation, a Date of Incorporation, a Number of Employees, Product being Sold or Marketed, Location of the Business and It's Various Divisions, a Total Annual Sales of Business, an Estimated Annual Credit Card Purchases, an Expected Average Credit Card Transaction, a Sales Tax Rate, a Percentage of Credit Card Purchases for Products, a Percentage of Credit Card Purchases for Services, a Method of Advertising, and information whether the party registering currently using the credit card as a preferred method of payment, and other related information; and
store buyer information including at least one of a Business name, a Business Legal Name, a Business address including a City, a State, and a Zip Code, a Name of an Authorized Signer, a Title of the Authorized Signer, a Business Phone Number, a Business Fax Number, an “Attention to” identifying where the communication must be send to, an Email address, an URL address, a Domain Name, a State of Incorporation, a Date of Incorporation, a Number of Employees, Product being Sold or Marketed, Location of the Business and It's Various Divisions, a Total Annual Sales of Business, an Estimated Annual Credit Card Purchases, an Expected Average Credit Card Transaction, a Sales Tax Rate, a Percentage of Credit Card Purchases for Products, a Percentage of Credit Card Purchases for Services, a Method of Advertising, and information whether the party registering currently using the credit card as a preferred method of payment, and other related information.

66. A system according to claim 60 wherein said server system further configured to enter information at least through one of a voice activation command and a device connected to the client system.

67. A system according to claim 60 wherein said server system further configured to:
track the online transaction information on a real time basis; and
store the online transaction information against an identifier on a real time basis by updating stored information by adding the new information to the centralized database on a real time basis to provide up-to-date deal information instantaneously to the user upon a request.

68. A system according to claim 67 wherein said server system further configured to:
download requested information from a server system; and
display requested information on a client system in response to the inquiry.

69. A system according to claim 68 wherein said server system further configured to print the requested information in a pre-determined format.

70. A system according to claim 51 wherein said server system further configured to accept an inquiry from a user.

71. A system according to claim 70 wherein said server system further configured to:
receiving an inquiry from the client system; and
display information on the client system.

72. A system according to claim 71 wherein said server system further configured to submit a request through at least one of pull down menus, check boxes, and hypertext links.

73. A system according to claim 71 wherein said server system further configured to display an HTML document downloaded by the server system.

74. A system according to claim 71 wherein said server system further configured to display at least one alternative from various alternatives available to the user.

75. A system according to claim 71 wherein said server system further configured to:
access the centralized database;
search the database regarding the specific inquiry;
retrieve information from the database; and
transmit the retrieved information to the client system for display by the client system.

76. A system according to claim 71 wherein said server system further configured to extract transaction details tracking data into at least one of a database software and a financial spread sheet software.

77. A system according to claim 71 wherein said server system further configured to receive data extracts from at least one of a database software and a financial spread sheet software.

78. A database comprising:
data corresponding to buyers and cross referencing the buyers data against unique identifiers;
data corresponding to sellers and cross referencing the sellers data against unique identifiers; and
data corresponding to various registration service providers.

79. A database according to claim 79 further comprising data corresponding to at least one of Service Bureaus, FD Solutions, OC/PC Data, ACH Money Transfer, Buyer Services Data, and other Services Data.

80. A database according to claim 79 further comprising data corresponding to buyers preferences for products and services.

81. A database according to claim 79 further comprising data corresponding to sellers preferences for payment processing methods.

82. A database according to claim 79 further comprising data corresponding to buyers and sellers preferences for future sales projections.

83. A computer program embodied on a computer readable medium for managing online transactions, comprising: a code segment that sets up user profiles of buyers and sellers and issues a user account number through an online registration process;
a code segment that maintains a database by adding, deleting and updating information;
a code segment that tracks transaction details according to assigned priorities;
a code segment that approves online transactions; and
a code segment that generates management reports to inform buyers and sellers.

84. The computer program according to claim 83 further includes a code segment that provides flexibility to an administrator to modify the user profile information.

85. The computer program according to claim 83 further includes a code segment that provides online help to the user by downloading a user manual on to a client device.

86. The computer program according to claim 83 further including a code segment that provides an option to the administrator which includes at least one of changing company profile option, changing payment information option, changing organization structure option, updating users option, changing administrator option, and updating product table option.

87. A computer program embodied on a computer readable medium for managing online transactions between buyers and sellers said program comprising:
a code segment that processes registration;
a code segment that manages client information;
a code segment that handles digital certificate management;
a code segment that processes transactions; and
a code segment that manages administrative functions.

88. The computer program according to claim 87 wherein the network is a wide area network operable using a protocol including at least one of TCP/IP and IPX.

89. The computer program according to claim 87 wherein the data is received from the user via a graphical user interface.

90. The computer program according to claim 87 further includes a code segment that assigns priority to transactions based on system's capability.

91. The computer program according to claim 90 further includes a code segment that provides overwriting authority to a manager having a supervisory authority to reset the transactional priority assigned by the system.

92. The computer program according to claim 87 further includes a code segment that monitors work load and manages performance of administrative staff.

93. The computer program according to claim 87 includes a code segment that displays information through an HTML document downloaded by the server system.

94. The computer program according to claim 87 further comprising:
a code segment that accesses the centralized database;
a code segment that searches the database regarding the specific inquiry;
a code segment that retrieves information from the database; and
a code segment that causes the retrieved information to be displayed on the client system.

95. The computer program according to claim 87 further comprising a code segment that tracks online transactions.

96. The computer program according to claim 95 further comprising a code segment that ensures that goods are delivered to the buyer and payments are received for said goods from the seller and credited to the seller's account after pre-determined fee for the online transaction has been deducted.

97. The computer program in accordance with claim 87 wherein the process registration code segment further includes a code segment that manages at least one of Central Registration Process, Credit Review & Rating Process, Account Activation Process, and a Digital Certificate Application Process.

98. The computer program in accordance with claim 87 wherein the client information code segment further includes a code segment that manages at least one of a Client Profile, Signatory Privileges, multi level Users, Fee Structure, and various Settlement Options.

99. The computer program in accordance with claim 87 wherein the digital certificate management code segment further includes a code segment that handles Digital Certificate Management, SurePay PKI, Issuance of Digital Certificates, Management of Digital Certificates, Authentication of Digital Certificates, and Revocation of Digital Certificates.

100. The computer program in accordance with claim 87 wherein the computer program in accordance with claim 87 further includes a code segment that manages a Central Integration Toolkit, a Transaction Switch, Transaction messaging, a Payment scheduler, Recurring Payments, Escrow Management, Financing, and Money Transfer.

101. The computer program in accordance with claim 87 wherein the administrative functions code segment further includes a code segment that manages Digital Certificate Administration, Data Import, Data Export, Online Queries, Online Statements, Integrated Billings, and User Profile Administration.

102. The computer program in accordance with claim 87 wherein the administrative functions code segment further includes a code segment that allows an administrator to import and export data from other commercial software.

103. The computer program in accordance with claim 87 wherein the administrative functions code segment of the computer program further includes a code segment that permits the administrator to change the user profile information including the users payment information, company's payment information, adding new users, editing user profiles, and deleting inactive users.

104. The computer program according to claim 87 wherein the client system and the server system are connected via a network and wherein the network is one of a wide area network, a local area network, an intranet and the Internet.

105. The computer program according to claim 87, and further comprising a code segment that monitors the security of the system by restricting access to unauthorized individuals.
